(19) United States
(12) Patent Application Publication
(10) Pub. No.: US 2008/0058105 A1
(43) Pub. Date: Mar. 6, 2008

(54) Casino Management

(76) Inventors: Fredrick C. Combs, Shawnee, OK (US); Gene Estep, Shawnee, OK (US)

Correspondence Address: FISH & RICHARDSON P.C., PO BOX 1022, MINNEAPOLIS, MN, 55440-1022, US

(21) Appl. No.: 11/847,883

(22) Filed: Aug. 30, 2007

Related U.S. Application Data
(60) Provisional application No. 60/841,790, filed on Aug. 31, 2006.

(51) Int. Cl. G06F 17/00

(52) U.S. Cl. 463/42; 463/25; 707/3

(57) ABSTRACT

The subject matter of this specification can be embodied in, among other things, a method that includes receiving a first report having a human-readable format for display to a user and a second report having a protocol-encoded format that requires additional processing to a human-readable format before display to a user. Each report has gaming information associated with one or more electronic gaming machines (EGMs). The method also includes identifying, for the first and second reports, formatting topologies that specify locations of the gaming information within the reports, extracting and aggregating the gaming information from the first and second reports using the identified formatting topologies, and outputting at least a portion of the aggregated gaming information in a uniform format for use in reporting gaming activity for the one or more EGMs.

### RELATED APPLICATIONS

This application claims benefit from Provisional Application No. 60/841,790 filed on Aug. 31, 2006 entitled “CASINO MANAGEMENT SYSTEM,” the entirety of which is incorporated by reference here.

### TECHNICAL FIELD

This instant specification relates to systems and methods for managing casino gaming information.

### BACKGROUND

Electronic gaming machines (EGMs) used in casinos can log game play data, such as the amount of cash played and the amount of cash won. A vendor of the EGM can use a server that is connected to the vendor's EGMs to retrieve the logged information and generate a report that includes that vendor's EGMs. A casino can have EGMs from multiple vendors, each of which may generate reports using disparate formats.

### SUMMARY

In general, this document describes casino management systems and methods that are used, for example, to consolidate and integrate human-readable gaming reports and machine-readable gaming reports into a central database.

In a first general aspect, a computer-implemented method is described. The method includes receiving a first report having a human-readable format for display to a user and a second report having a protocol-encoded format that requires additional processing to a human-readable format before display to a user. Each report has gaming information associated with one or more electronic gaming machines (EGMs). The method also includes identifying, for the first and second reports, formatting topologies that specify locations of the gaming information within the reports, extracting and aggregating the gaming information from the first and second reports using the identified formatting topologies, and outputting at least a portion of the aggregated gaming information in a uniform format for use in reporting gaming activity for the one or more EGMs.

In a second general aspect, a system for aggregating gaming information is described. The system includes an interface for receiving a first report having a human-readable format for display to a user and a second report having a protocol-encoded format that requires additional processing to a human-readable format before display to a user. Each report has gaming information for one or more electronic gaming machines (EGMs) associated with a vendor. The system also includes a translation system for extracting the gaming information from the first and second reports using formatting topologies that map report fields from the first and second reports to database fields used by a database and for storing the extracted gaming information in the database, and the system includes a report generator for retrieving at least a portion of the gaming information from the database and outputting a report comprising gaming activity for EGMs associated with different vendors.

The systems and techniques described here may provide one or more of the following advantages. First, an architecture using mapping plug-ins to define a mapping topology can be used to increase flexibility. Second, user convenience can be increased by providing an automatic aggregation of multiple EGM vendor reports into a single report. Third, accuracy can be increased by facilitating a real-time display of gaming activity for EGMs and player activity. Fourth, human-readable reports and machine-readable reporting data can be translated into a uniform format for storage in a database.

The details of one or more embodiments of the casino management feature are set forth in the accompanying drawings and the description below. Other features and advantages of the casino management feature will be apparent from the description and drawings, and from the claims.

### DESCRIPTION OF DRAWINGS

FIG. 1 is a schematic diagram showing an example of a system for generating an aggregated report of electronic gaming machine data.

FIG. 2 is a flow chart showing an example of a process for generating an aggregated report of electronic gaming machine data.

FIG. 3 is a schematic diagram showing an example of a system for storing electronic gaming machine data.

FIG. 4 is a schematic diagram showing another example of a system for generating an aggregated report of electronic gaming machine data.

FIG. 5 is an example of a user interface for presenting dynamic information relating to casino patron activity and electronic gaming machine activity.

FIG. 6 is a schematic diagram of a computing system that can be used in connection with computer-implemented methods described in this document.

Like reference symbols in the various drawings indicate like elements.

### DETAILED DESCRIPTION

This document describes systems and techniques for managing reports from gaming devices having multiple vendor formats. In certain implementations, one of the vendor formats is a human readable file, such as a PDF document or a spreadsheet, and another vendor format is in a machine-readable form, such as a protocol-encoded message. In certain implementations, both human-readable and machine-readable gaming device reports are translated into a common format for storage and for generating a report that aggregates data from the gaming device reports.

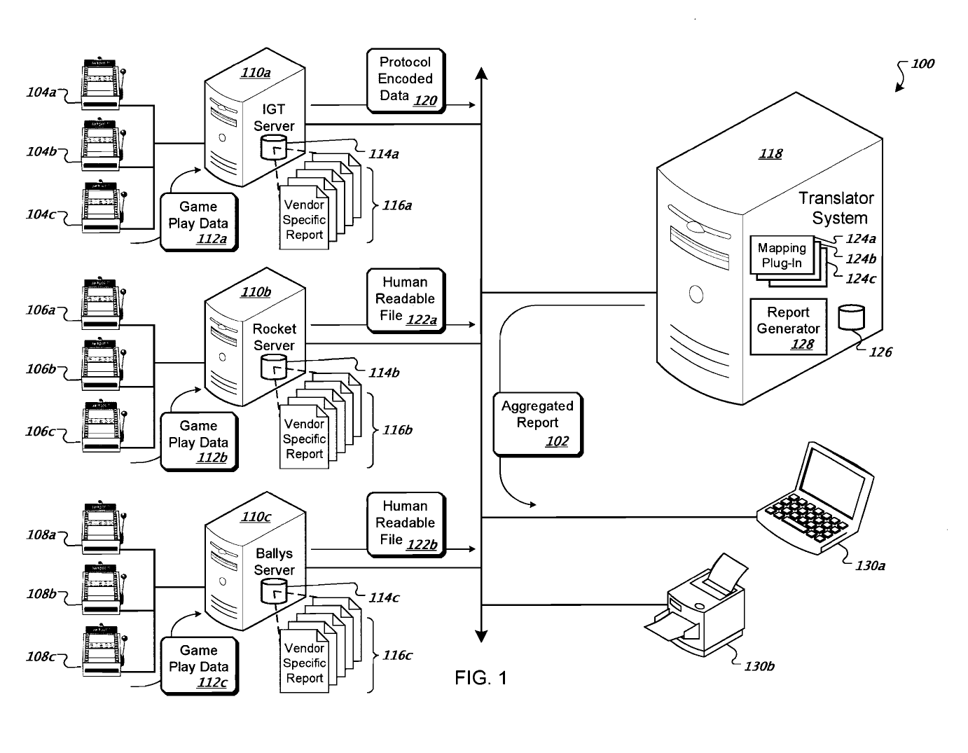

FIG. 1 is a schematic diagram showing an example of a system 100 for generating an aggregated report 102 of electronic gaming machine data. The system 100 includes one or more electronic gaming devices 104a-c, such as slot machines, bingo machines, or poker machines. The electronic gaming devices 104a-c have a first vendor format (e.g., a format associated with the vendor “IGT”). The system 100 also includes one or more electronic gaming devices 106a-c having a second vendor format (e.g., a format associated with the vendor “Rocket”). The system 100 may include additional electronic gaming devices, such as one or more electronic gaming devices 108a-c having a third vendor format (e.g., a format associated with the vendor “Ballys”). The system 100 also includes multiple servers 110a-c. In this example, the servers 110a-c correspond to the first, second, and third vendor formats, respectively.

The electronic gaming devices 104a-c, 106a-c, and 108a-c record information, such as cash in, cash out, number of games played, and number of games won by users at the electronic gaming devices 104a-c, 106a-c, and 108a-c. The electronic gaming devices 104a-c, 106a-c, and 108a-c send the recorded information as game play data 112a-c to the servers 110a-c, respectively.

The servers 110a-c include one or more storage devices 114a-c, respectively. The servers 110a-c store the game play data 112a-c in the storage devices 114a-c as one or more vendor specific reports 116a-c, respectively. The vendor specific reports 116a-c have a format that is associated with the vendor or provider of the servers 110a-c, respectively. The servers 110a-c send the vendor specific reports 116a-c to a translator system 118. In the implementation shown in FIG. 1, the servers 110a-c send the vendor specific reports 116a-c as protocol-encoded data 120 or human readable files 122a-b.

In certain implementations, the translator system 118 includes multiple mapping plug-ins 124a-c that correlate or map a variety of gaming machine output information to a uniform format. For example, the servers 110a-c may output the vendor specific reports 116a-c in proprietary formats or industry standard formats, such as the SAS protocol. The translator system 118 may automatically capture the output information from the electronic gaming devices 104a-c, 106a-c, and 108a-c or the servers 110a-c and translate the information into predetermined fields in a centralized database 126.

In some implementations, gaming vendors' reports are generated by the vendors' gaming machines and stored in memory, such as on a thumb drive, a hard disk, a network drive, etc. The reports can include information such as payout, number of games played on a gaming machine, amount of cash collected, frequency of play by particular patrons, and may be collected based on a predetermined period, such as a daily collection.

The vendor reports can be in various file formats, such as comma separated value (CSV) format, Portable Document Format (PDF), Rich Text Format (RTF), or an Excel spreadsheet file format. Additionally, the vendor reports can display the information differently. For example, some reports may include the cash payout amount at the right hand of the second page, whereas other reports may include the cash payout amount on the bottom line of the first page. In another example, the reports may be represented as a single string of fields followed by values. The order, the field names, and value types and lengths may vary between each vendor report.

To import the vendor specific reports 116a-c into the centralized database 126, a user may select a particular vendor specific report from the storage devices 114a-c. Optionally, the user may also designate the type of report that has been selected. For example, the user may specify that the selected report is from the “Ballys” gaming system. In other implementations, the translator system 118 can parse the selected report and search for text that indicates which gaming system or vendor generated the report. For example, the report may include a field that specifies the types of games played or the vendor's name. If information used to derive the vendor's identity, such of the type of games played, is provided, the translator system 118 can reference a vendor lookup table to determine what vendor is associated with the information (e.g., game type).

In certain implementations, after the type of report has been determined by the translator system 118 (e.g., based on user input or system determinations), the translator system 118 accesses a mapping plug-in that corresponds to the vendor. Each of the mapping plug-ins 124a-c can include a description of the topology of each vendor report (or vender transmission protocol). A mapping plug-in can store (or can access) information, such as the layout of the report, which may include the position and location of the fields and associated field values. For example, the mapping plug-in may have information that informs the system that the first field in the report is a “cash out amount” field followed by a dollar value of between $100,000,000.00 and zero.

The architecture of using mapping plug-ins to define the topology and mapping for each vendor can increase the flexibility of the system 100 and can permit convenient addition of new vendors, or upgrading of previous vendor's file format or report layout.

In certain implementations, the selected mapping plug-in can extract data from the report and insert it into a database, such as the centralized database 126. The data in the reports can be mapped to corresponding fields in the centralized database 126 because the topology of the report is known by the selected mapping plug-in and the fields in the centralized database 126 are predetermined.

In certain implementations, the topology known by the mapping plug-in is incomplete, outdated, or incorrect. In this case, the mapping plug-in can resort to an optical character recognition (OCR) algorithm to recognize text in the vendor report and map it with corresponding fields in the centralized database 126. For instance, if a mapping plug-in attempts to extract data from a position in the report that is blank (e.g., returns a null value), the plug-in can use an OCR algorithm to search the report for the desired field identifier and then extracts data associated with that field.

For example, if a plug-in is unsuccessful in extracting a cash out value from a position on a first page of a report, the plug-in can initiate an OCR algorithm that searches the report for the text “cash out” (or other term that a vender uses to describe this value). After the text is located, the OCR algorithm can identify nearby text (e.g., numerical values) and return the identified text as the “cash out” value. In certain implementations, the system identified text can be presented for verification to a user.

After the data has been imported, validation algorithms can be run to ensure the data's integrity. For example, the counting information is checked to make sure it is not combined or confused with other reporting information, such as the number of transactions on the electronic gaming devices 104a-c, 106a-c, and 108a-c. Alternatively, the validation of data may be run before the data is imported into the centralized database 126. This may prevent the input of corrupted data into the translator system 118.

As shown in FIG. 1, the translator system 118 also can include a report generator 128 that generates the aggregated report 102. For example, the report generator 128 can calculate totals of cash in and cash out for all the electronic gaming devices within a casino regardless of which electronic gaming device is associated with which vendor. For example, the report generator 128 can track the winnings or losses of a player across the multiple formats of electronic gaming devices. In some implementations, the translator system 118 outputs the aggregated report 102 to a user of one or more input/output devices 130a-b.

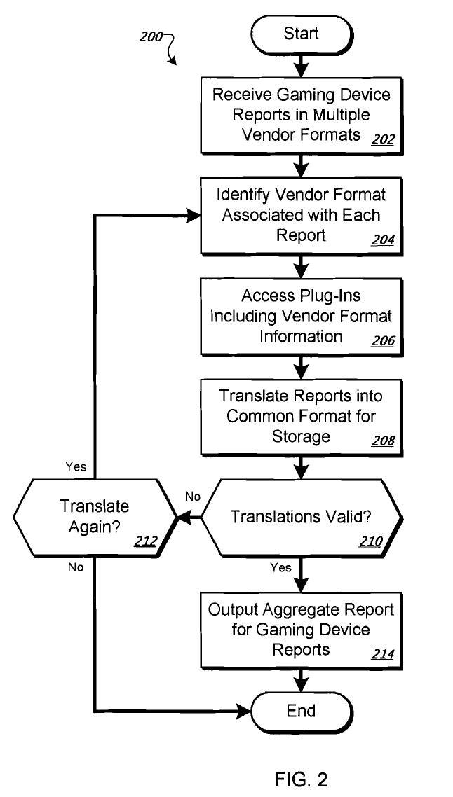

FIG. 2 is a flow chart showing an example of a process 200 for generating an aggregated report of electronic gaming machine data. The process 200 may be performed, for example, by a system such as the system 100. For clarity of presentation, the description that follows uses the system 100 as the basis of an example for describing the process 200. However, another system, or combination of systems, may be used to perform the process 200.

The process 200 receives (202) gaming device reports in multiple vendor formats. For example, the translator system 118 receives the protocol-encoded data 120 and the human readable files 122a-b in the “IGT,” “Rocket,” and “Ballys” vendor formats.

The process 200 identifies (204) the vendor formats associated with each of the gaming device reports. For example, the process 200 may receive a user input associating one or more gaming device reports with a vendor format of a particular type. The process 200 may receive a system generated input associating one or more gaming device reports with a vendor format of a particular type. The process 200 may parse and analyze a gaming device report to determine a vendor format. Particularly, the process 200 may locate an identifier or determine a structure within a gaming device report, where the identifier or structure is associated with a particular vendor format.

The process 200 accesses (206) plug-ins that include vendor report formatting information for the identified vendor formats. For example, the translator system 118 accesses the mapping plug-ins 124a-c. Each of the mapping plug-ins may be associated with a particular vendor format, such as “IGT,” “Rocket,” and “Ballys,” respectively.

The process 200 translates (208) the gaming device reports into a common format for storage in a central database using the plug-ins. For example, the translator system 118 uses the mapping plug-ins 124a-c to translate the protocol-encoded data 120 and the human readable files 122a-b, respectively, into a common format for storage in the centralized database 126.

If the process 200 determines that one or more of the translations are invalid (210) and the process 200 attempts the translation again (212), then the process 200 identifies (204) the vendor formats of the gaming device reports again. Otherwise, if the process 200 does not attempt the translation again (212) (e.g., two or more translation attempts have failed), then the process 200 ends.

In some implementations, the process 200 may compare data extracted from gaming device reports to corresponding historical or peer data to determine if the translations are invalid. For example, the process 200 can compare the extracted cash out amounts for each electronic gaming device. If one gaming device has a cash out value of $30,000 and surround gaming devices have a cash out value of $550, the translation (212) can be attempted again. In another example, if the gaming device has a cash out value of $30,000, but historically has had a cash out value of $1,000 (+/−15%), the translation (212) can be re-attempted. In other implementation, the process 200 can alert a user to initiate a manual review when an error occurs.

If the process 200 determines that the translations are valid (210), then the process 200 outputs an aggregated report of the gaming device reports. For example, the report generator 128 may generate the aggregated report 102 and output the aggregated report to the input/output devices 130a-b.

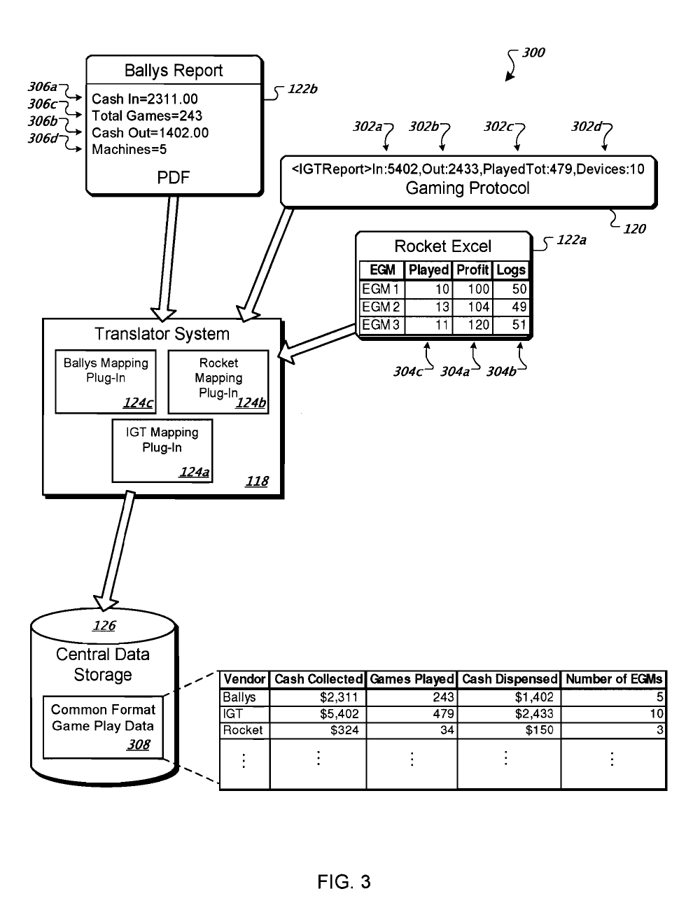

FIG. 3 is a schematic diagram showing an example of a system 300 for storing electronic gaming machine data. Particularly, the translator system 118 uses the mapping plug-ins 124a-c to identify the electronic gaming machine data within the protocol-encoded data 120 and the human readable files 122a-b.

The protocol-encoded data 120 includes multiple data fields 302a-d. The data field 302a includes the identifier “In” and the value “5402.” Accordingly, the mapping plug-in 124a determines that the protocol-encoded data 120 includes a cash collected value of $5,402. The data field 302b includes the identifier “Out” and the value “2433.” Accordingly, the mapping plug-in 124a determines that the protocol-encoded data 120 includes a cash dispensed value of $2,433. The data field 302c includes the identifier “PlayedTot” and the value “479.” Accordingly, the mapping plug-in 124a determines that the protocol-encoded data 120 includes an indication that 479 games were played. The data field 302d includes the identifier “Devices” and the value “10.” Accordingly, the mapping plug-in 124a determines that the protocol-encoded data 120 indicates that there are 10 electronic gaming devices reported in the protocol-encoded data 120.

The human readable file 122a includes multiple columns of data fields 304a-c for three electronic gaming devices. The column of data fields 304a includes the identifier “Profit” and the values “100,” “104,” and “120.” Accordingly, the mapping plug-in 124b determines that the human readable file 122a includes a cash collected value of $324 (e.g., the sum of the values in the column of data fields 304a). The data field 302b includes the identifier “Loss” and the values “50,” “49,” and “51.” Accordingly, the mapping plug-in 124b determines that the human readable file 122a includes a cash dispensed value of $150. The column of data fields 304c includes the identifier “Played” and the values “10,” “13,” and “11.” Accordingly, the mapping plug-in 124b determines that the human readable file 122a includes an indication that 34 games were played. The human readable file 122a includes rows of data for three electronic gaming devices. Accordingly, the mapping plug-in 124b determines that the human readable file 122a indicates that there are 3 electronic gaming devices reported in the human readable file 122a.

The human readable file 122b includes multiple data fields 306a-d. The data field 306a includes the identifier “Cash In” and the value “2311.00.” Accordingly, the mapping plug-in 124c determines that the human readable file 122b includes a cash collected value of $2,311. The data field 306b includes the identifier “Cash Out” and the value “1402.00.” Accordingly, the mapping plug-in 124c determines that the human readable file 122b includes a cash dispensed value of $1,402. The data field 306c includes the identifier “Total Games” and the value “243.” Accordingly, the mapping plug-in 124c determines that the human readable file 122b includes an indication that 243 games were played. The data field 306d includes the identifier “Machines” and the value “5.” Accordingly, the mapping plug-in 124c determines that the human readable file 122b indicates that there are 5 electronic gaming devices reported in the human readable file 122b.

The translator system 118 stores the translated reports as common format game play data 308 in the centralized database 126. The centralized database 126 may be included within the translator system 118 or separate from the translator system 118. The centralized database 126 may be a monolithic database or distributed across multiple systems.

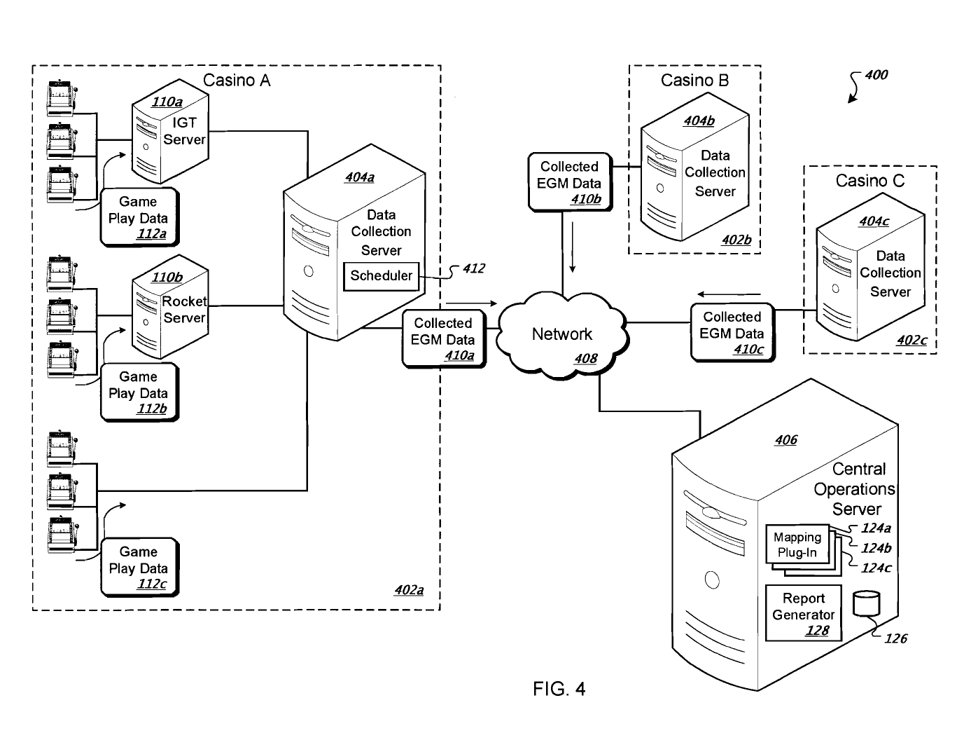

FIG. 4 is a schematic diagram showing an example of a system 400 for generating an aggregated report of electronic gaming machine data. The system 400 includes multiple casinos 402a-c and one or more data collection servers 404a-c at the casinos 402a-c, respectively. The data collection servers 404a-c collect electronic gaming machine (EGM) information at the casinos 402a-c. The data collection server 404a-c are in communication with a central operations server 406 through a network 408. The data collection servers 404a-c send the collected information as collected EGM data 410a-c, respectively, to the central operations server 406.

The data collection servers 404a-c may translate the EGM data into the common format before sending the collected EGM data 410a-c to the central operations server 406. Alternatively, the central operations server 406 may translate the collected EGM data 410a-c. The central operations server 406 and/or the data collection server 404a-c may generate aggregated reports of EGM data as previously described.

In some implementations, the system 400 can gather reporting information directly from a vendor system without having to specify a location at which the information, or report, is stored. For example, a data collection server (DCS) can be coupled to each vendor's gaming server, which is in turn, coupled to the electronic gaming devices. In one implementation, the DCS is a server with a plurality of set for networking ports, each of which is coupled to a different vendors a game server.

A DCS, such as the DCS 404a, can obtain the reports by running a scheduler 412 that initiates operations that select the report file on the vendors gaming server for retrieval. In other implementations, the game server can transmit the gaming information to the DCS at predetermined intervals. The retrieved transmitted file may then be accessed by the plug-in corresponding to the vender's gaming system to which the DSC is coupled and the translated data is stored as described above.

In other implementations, the DCS is coupled more directly to the vendor's games without being coupled to the gaming server. For example, the games may be connected to a serial server that forwards the gaming information, such as payout information to a connected device. The DCS can be coupled to the serial server and gather data directly from the gaming devices.

The DCS can include plug-ins that store the format of the transmission protocol used by the serial server, such as SAS, and can translate the SAS information into a common format that is stored in a database in real time.

Additionally, bidirectional communication may be possible between the gaming devices in the DCS server. For example, the DCS server can diagnose the machine's operation remotely.

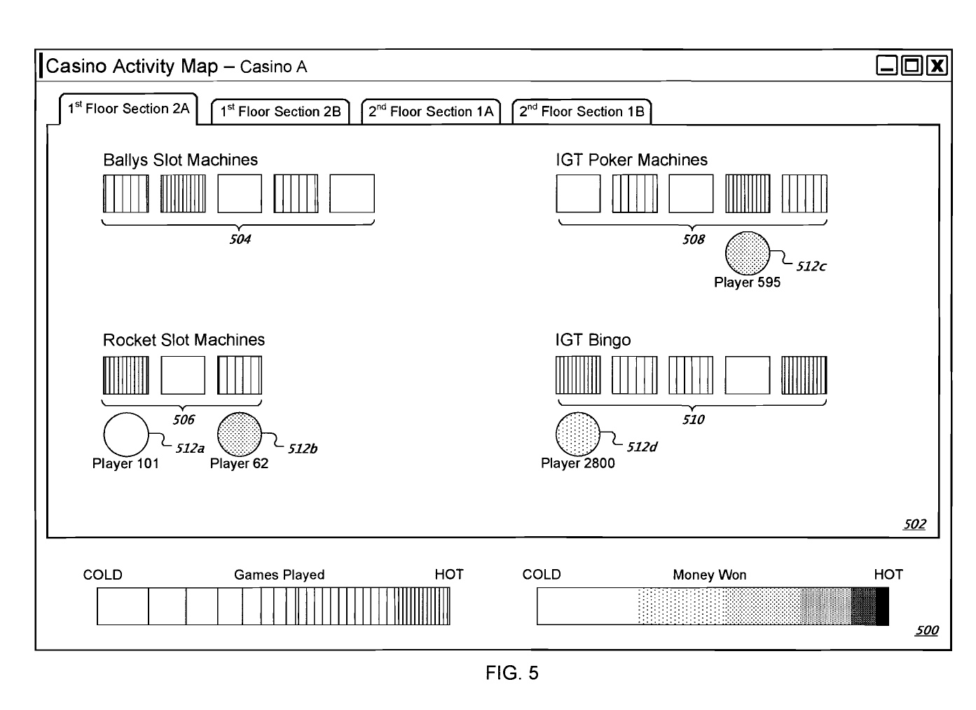

FIG. 5 is an example of a user interface 500 for presenting dynamic information relating to casino patron activity and electronic gaming machine activity.

The user interface 500 presents maps of activity for locations within a particular casino. The user interface 500 includes a report area 502 that presents the activity in a particular location of the casino. Here, a user has selected “1^{st} Floor Section 2A” for presentation in the report area 502.

The report area 502 includes representations of multiple electronic gaming devices 504 from the vendor “Ballys” and multiple electronic gaming devices 506 from the vendor “Rocket.” The report area 502 also includes representations of multiple electronic gaming devices 508 of a first type (poker machines) and multiple electronic gaming devices 510 of a second type (bingo) from the vendor “IGT.”

The representations of the electronic gaming devices indicate the number of games played at each of the electronic gaming devices. A high density of lines indicates a high number of games played and a low density of lines indicates a low number of games played at a particular electronic gaming device. The indication may be graphical (as shown here), numeric, or a combination of graphical and numeric representations. Alternatively, a graphical representation may use colors or shapes to indicate a number of games played or other EGM data.

The report area 502 also includes representations of one or more players 512a-d. The representations of the players 512a-d indicate the amount of money won by the particular player. A high density of dots indicates a high amount of money won and a low density of dots indicates a low amount of money won by the particular player. The amounts may be calculated for a recent game play, an aggregate over game plays at a particular electronic game device, or an aggregate over game plays for a period of time (e.g., daily, weekly, monthly, yearly, or lifetime). The amounts may be aggregated over multiple casinos as well.

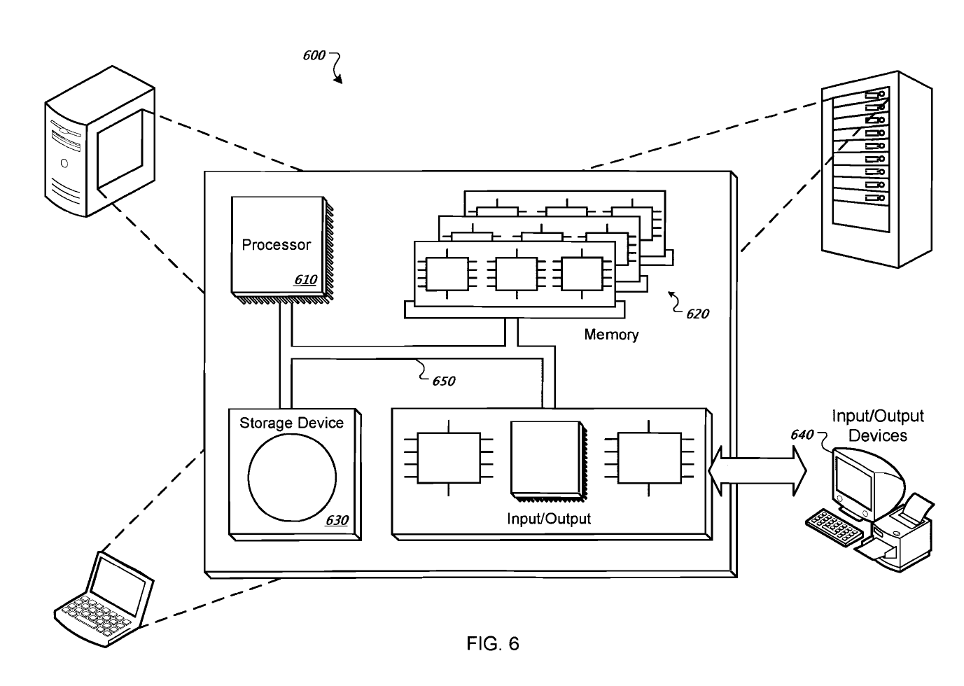

FIG. 6 is a schematic diagram of a generic computer system 600. The system 600 can be used for the operations described in association with any of the computer-implement methods described previously, according to one implementation. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, the user interface 500 may present EGM data aggregated over multiple casinos, locations within casinos, EGM vendors, EGM types, and/or time intervals.

In another example, a patron can take a cash out ticket from an EGM associated with a first vendor and insert it for use in an EGM associated with a different vendor. In some implementations, this is enabled because the EGMs are connected to a centralized computing system that can reconcile accounting information between different vendors.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
receiving a first report having a human-readable format for display to a user and a second report having a protocol-encoded format that requires additional processing to a human-readable format before display to a user, each report having gaming information associated with one or more electronic gaming machines (EGMs);
identifying, for the first and second reports, formatting topologies that specify locations of the gaming information within the reports;
extracting and aggregating the gaming information from the first and second reports using the identified formatting topologies; and
outputting at least a portion of the aggregated gaming information in a uniform format for use in reporting gaming activity for the one or more EGMs.

2. The method of claim 1, further comprising displaying the output aggregated gaming information in a graphical representation of a portion of a casino comprising representations of EGMs and the EGMs' associated gaming activity.

3. The method of claim 2, wherein the graphical representation further comprises representations of EGM players and the EGM players' associated gaming activity.

4. The method of claim 3, wherein the EGM player's associated activity, the EGMs' activity, or both are visually indicated using a heat map.

5. The method of claim 1, wherein one or more EGMs associated with the first report are located in a first gaming facility and one or more EGMs associated with the second report are located in a second gaming facility geographically distanced from the first gaming facility.

6. The method of claim 1, wherein the gaming information comprises information related to one or more players of the EGMs.

7. The method of claim 1, wherein the receipt of the first or second report is substantially concurrent with an occurrence of a gaming event at an EGM, wherein the gaming event initiates generation of the first or second report that includes information associated with the gaming event.

8. The method of claim 1, wherein the first or second report is received from a gaming server that aggregates the gaming information from multiple EGMs for inclusion in the first or second report.

9. The method of claim 1, wherein the formatting topologies are included in mapping plug-ins, each of which comprise modular executable code configured to integrate with a translation module that is used to extract and aggregate the gaming information.

10. The method of claim 1, wherein aggregating the gaming information comprises aggregating data associated with gaming activity for multiple EGMs described in either the first or second report.

11. The method of claim 1, wherein aggregating the gaming information comprises aggregating data associated with gaming activity for the one or more EGMs described in the first and second report.

12. The method of claim 1, wherein the human-readable format comprises a spreadsheet format, a PDF format, or a text format.

13. The method of claim 1, wherein the protocol-encoded format comprises a SAS protocol format, a S2S protocol format, or a G2S protocol format.

14. The method of claim 1, further comprising validating the extracted gaming information using historical gaming information to determine whether the extracted gaming information exceeds thresholds derived from the historical gaming information.

15. The method of claim 1, further comprising validating the extracted gaming information using gaming information from one or more peers to determine whether the extracted gaming information exceeds thresholds derived from the one more peers' gaming information.

16. The method of claim 15, wherein a peer comprises another EGM or EGM player.

17. The method of claim 1, wherein the output comprises a human-readable report that aggregates gaming information from EGMs associated with different EGM vendors.

18. The method of claim 1, further comprising receiving an indication of a dispensation of a cash out ticket at a first EGM and transmitting information indicative of approval to play a second EGM for an amount associated with the cash out ticket when the cash out ticket is inserted in the second EGM.

19. A system for aggregating gaming information comprising:
an interface for receiving a first report having a human-readable format for display to a user and a second report having a protocol-encoded format that requires additional processing to a human-readable format before display to a user, each report having gaming information for one or more electronic gaming machines (EGMs) associated with a vendor;
a translation system for extracting the gaming information from the first and second reports using formatting topologies that map report fields from the first and second reports to database fields used by a database and for storing the extracted gaming information in the database; and
a report generator for retrieving at least a portion of the gaming information from the database and outputting a report comprising gaming activity for EGMs associated with different vendors.

20. The system of claim 19, wherein the formatting topologies are stored in plug-ins comprising modular executable code that is called by the translation system.

21. A computer program product tangibly embodied in a computer readable medium, the computer program product including instructions that, when executed, perform operations for managing gaming information, the operations comprising:
receiving a first report having a human-readable format for display to a user and a second report having a protocol-encoded format that requires additional processing to a human-readable format before display to a user, each report having gaming information associated with one or more electronic gaming machines (EGMs);
identifying, for the first and second reports, formatting topologies that specify locations of the gaming information within the reports;
extracting and aggregating the gaming information from the first and second reports using the identified formatting topologies; and
outputting at least a portion of the aggregated gaming information in a uniform format for use in reporting gaming activity for the one or more EGMs.
